(19) United States
(12) Patent Application Publication
(10) Pub. No.: US 2003/0077544 A1
(43) Pub. Date: Apr. 24, 2003

(54) Faraday cups, and charged-particle-beam microlithography apparatus comprising same

(75) Inventor: Hajime Yamamoto, Kumagaya (JP)

Correspondence Address: KLARQUIST SPARKMAN, LLP, One World Trade Center, Suite 1600, 121 S.W. Salmon Street, Portland, OR, 97204, US

(73) Assignee: Nikon Corporation

(21) Appl. No.: 10/232,921

(22) Filed: Aug. 30, 2002

(30) Foreign Application Priority Data
Aug. 31, 2001 (JP) 2001-263179

(51) Int. Cl. G03B 27/42; G03C 5/00

(52) U.S. Cl. 430/296; 355/53; 430/942; 438/949

(57) ABSTRACT

Faraday cups are provided that serve as beam-current measuring devices especially in charged-particle-beam microlithography apparatus. The Faraday cups are configured to reduce beam displacements otherwise caused by eddy currents generated in the Faraday cup. An embodiment of a Faraday cup includes a main body, a stand 51, and a sleeve member. The main body is constructed of a material having a volume resistivity of at least approximately 10⁻⁶Ω-m and/or a volume of 150 mm³ or less. The main body desirably is situated at least 4 mm from a substrate-mounting region or from a calibration mark on the substrate stage of the microlithography apparatus.

### FIELD

This disclosure pertains to microlithography, which is a key technology used in the fabrication of micro-electronic devices such as semiconductor integrated circuits, displays, and the like. More specifically, this disclosure pertains to microlithography performed using a charged particle beam such as an electron beam or ion beam. Even more specifically, the disclosure pertains to charged-particle detectors, termed “Faraday cups,” used in charged-particle-beam microlithography apparatus, and to using such detectors for reducing beam displacement due to eddy currents and for performing pattern transfer with high accuracy and precision on a substrate mounted to a stage moving at high velocity.

### BACKGROUND

In an electron-beam microlithography apparatus (generally representative of charged-particle-beam (CPB) microlithography apparatus), a detector termed a “Faraday cup” typically is situated on the substrate stage and used for measuring the beam current of an electron beam incident to the substrate stage. The Faraday cup normally is selected from any of various configurations that are relatively large and that are made of a light phosphor bronze, aluminum, or other material that can be machined easily.

As CPB microlithography apparatus and methods have undergone extensive refinement in recent years, substantial demands are made on such apparatus to perform microlithography under conditions in which the substrate stage is moving at high velocity and in which pattern-transfer accuracy is several nanometers. Under these conditions, eddy currents tend to be generated in the Faraday cup. The eddy currents tend to generate corresponding magnetic fields that can cause unwanted beam displacements, resulting in degraded pattern-transfer accuracy.

### SUMMARY

In view of the shortcomings of the prior art as summarized above, the present invention provides, inter alia, CPB microlithography apparatus that include a Faraday cup and that exhibit reduced beam displacements due to eddy currents generated in the Faraday cup, compared to conventional apparatus. Thus, the apparatus are capable of performing pattern transfer at high accuracy on a substrate mounted on a substrate stage moving at high velocity.

According to a first aspect of the invention, Faraday cups are provide that are configured to capture charged particles of an incident charged particle beam. An embodiment of such a Faraday cup is connectable to an electrical-current measuring device (e.g., ammeter) and is constructed of a material having a volume resistivity of approximately 10⁻⁶Ω·m or higher. Alternatively or in addition, the Faraday cup includes an electrically conductive portion having a volume of 150 mm³ or less.

Another embodiment of a Faraday cup is connectable to an electrical-current measuring device and comprises an electrically conductive portion having a volume of 150 mm³ or less.

According to another aspect of the invention, microlithographic exposure apparatus are provided that comprise a Faraday cup such as any of the embodiments summarized above.

According to another aspect of the invention, microlithographic exposure apparatus are provided that comprise a charged-particle-beam (CPB) optical system, a substrate stage, and a Faraday cup. The CPB optical system can be an electron-optical system of which the beam is an electron beam. The substrate stage is situated relative to the CPB optical system and comprises a substrate-holding region and a calibration mark. The substrate stage is configured to hold a lithographic substrate at the substrate-holding region. The substrate stage also is movable to allow the CPB optical system to focus a charged particle beam onto a selected location on an exposure-sensitive surface of the substrate held on the substrate-holding region, so as to expose the surface of the substrate in a lithographic manner. The Faraday cup is situated on the substrate stage at a distance of at least 4 mm from the substrate-holding region of the substrate stage or from the calibration mark, wherein the Faraday cup is configured for measuring a beam current of a charged particle beam incident on the Faraday cup.

As noted above, the Faraday cup desirably is made of a material having a volume resistivity of at least approximately 10⁻⁶ Ω·m, and/or comprises an electrically conductive portion having a volume of 150 mm³ or less.

According to yet another aspect of the invention, methods are provided, in the context of a microlithography method, for measuring the beam current of a charged particle beam as incident on a substrate stage. I.e., the pattern is exposed lithographically onto a lithographic substrate using a charged particle beam, while the substrate is mounted, for exposure, on the substrate stage. In an embodiment of the method, a Faraday cup is mounted at a location relative to the charged particle beam and the substrate stage such that the Faraday cup can capture charged particles of an incident charged particle beam. The Faraday cup comprises a material having a volume resistivity of approximately 10⁻⁶ Ω·m or higher, and is connected to an electrical-current measuring device (e.g., ammeter). Based on data produced by the electrical-current measuring device as the charged particle beam is incident on the Faraday cup, the beam current of the beam is determined. The Faraday cup desirably comprises an electrically conductive portion having a volume of 150 mm³ or less.

In another embodiment of the method, a Faraday cup is mounted at a distance of at least 4 mm from the substrate-holding region of the substrate stage or from a calibration mark on the substrate stage. The Faraday cup is connected to an electrical-current measuring device (e.g., ammeter) and, based on data produced by the electrical-current measuring device as the charged particle beam is incident on the Faraday cup, the beam current of the beam is determined. As noted above, the Faraday cup desirably comprises a material having a volume resistivity of approximately 10⁻⁶ Ω·m or higher and/or an electrically conductive portion having a volume of 150 mm³ or less.

In any event, by configuring the Faraday cup with a material having a high electrical resistivity and a small size, eddy currents generated in the Faraday cup, especially if the cup is mounted on a high-velocity substrate stage, are reduced to acceptable levels. Furthermore, by placing the Faraday cup the specified distance from the substrate-mounting region, the Faraday cup in fact is situated appropriately relative to the optical axis of the microlithography apparatus, thereby facilitating good suppression of eddy currents generated by the Faraday cup and the effects of the eddy currents on the beam.

The foregoing and additional features and advantages of the invention will be more readily apparent from the following detailed description, which proceeds with reference to the accompanying drawings.

### BRIEF EXPLANATION OF THE DRAWINGS

FIG. 1 is an elevational section of a representative embodiment of a Faraday cup.

FIG. 2 is an elevational schematic diagram of imaging relationships and control systems of a representative embodiment of a step-and-repeat type of electron-beam microlithography apparatus that includes a Faraday cup.

FIG. 3 is a plan view of a substrate stage, depicting an example disposition of the Faraday cup relative to a calibration mark and the wafer chuck.

FIG. 4 is an exemplary graph of image-placement error (IPE) as a function of the radius r of the main body of the Faraday cup.

FIG. 5 is an exemplary graph of image-placement error (IPE) as a function of distance d as shown in FIG. 3.

### DETAILED DESCRIPTION

The invention is described in the context of representative embodiments that are not intended to be limiting in any way. Also, the embodiments are described in the context of their use with electron-beam microlithography apparatus. However, it will be understood that the general principles described herein can be used with equal facility in a microlithography apparatus employing another type of charged particle beam, such as an ion beam. Furthermore, although the embodiments are described in the context of step-and-repeat microlithography apparatus, it will be understood that the subject apparatus can exploit any of various other exposure schemes, such as step-and -scan.

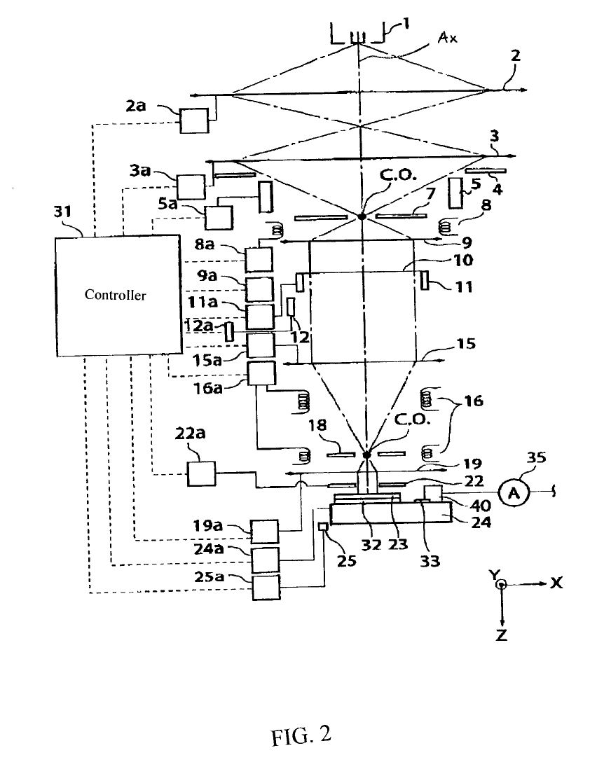

With respect to an exemplary step-and-repeat electron-beam microlithography apparatus, reference is made to FIG. 2, which depicts general control and optical relationships of various key components of the system.

Situated at the extreme upstream end of the system is an electron gun 1 that emits an electron beam propagating in a downstream direction generally along an optical axis Ax. Downstream of the electron gun 1 are a first condenser lens 2 and a second condenser lens 3 collectively constituting a two-stage condenser-lens assembly. The condenser lenses 2, 3 converge the electron beam at a crossover C.O. situated on the optical axis Ax at a blanking diaphragm 7.

Downstream of the second condenser lens 3 is a “beam-shaping diaphragm” 4 comprising a plate defining an axial aperture (typically rectangular in profile) that trims and shapes the electron beam passing through the aperture. The aperture is sized and configured to trim the electron beam sufficiently to illuminate one exposure unit (subfield) on the reticle 10. An image of the beam-shaping diaphragm 4 is formed on the reticle 10 by an illumination lens 9.

The electron-optical components situated between the electron gun 1 and the reticle 10 collectively constitute an “illumination-optical system” of the depicted microlithography system. The electron beam propagating through the illumination-optical system is termed an “illumination beam” because it illuminates a desired region of the reticle 10. As the illumination beam propagates through the illumination-optical system, the beam actually travels in a downstream direction through an axially aligned “beam tube” (not shown but well understood in the art) that can be evacuated to a desired vacuum level.

A blanking deflector 5 is situated downstream of the beam-shaping aperture 4. The blanking deflector 5 laterally deflects the illumination beam as required to cause the illumination beam to strike the aperture plate of the blanking diaphragm 7, thereby preventing the illumination beam from being incident on the reticle 10.

A subfield-selection deflector 8 is situated downstream of the blanking diaphragm 7. The subfield-selection deflector 8 laterally deflects the illumination beam as required to illuminate a desired reticle subfield situated within the optical field of the illumination optical system. Thus, subfields of the reticle 10 are scanned sequentially by the illumination beam in a horizontal direction (X-direction in the figure). The illumination lens 9 is situated downstream of the subfield-selection deflector 8.

The reticle 10 typically defines many subfields (e.g., tens of thousands of subfields). The subfields collectively define the pattern for a layer to be formed at a single die (“chip”) on a lithographic substrate. The reticle 10 is mounted on a movable reticle stage 11. Using the reticle stage 11, by moving the reticle 10 in a direction (Y and/or X direction) perpendicularly to the optical axis Ax, it is possible to illuminate the respective subfields on the reticle 10 extending over a range that is wider than the optical field of the illumination-optical system. The position of the reticle stage 11 in the XY plane is determined using a “position detector” 12 that typically is configured as a laser interferometer. A laser interferometer is capable of measuring the position of the reticle stage 11 with extremely high accuracy in real time.

Situated downstream of the reticle 10 are first and second projection lenses 15, 19, respectively, and an imaging-position deflector 16. The illumination beam, by passage through an illuminated subfield of the reticle 10, becomes a “patterned beam” because the beam has acquired an aerial image of the illuminated subfield. The patterned beam is imaged at a specified location on a substrate 23 (e.g., “wafer”) by the projection lenses 15, 19 collectively functioning as a “projection-lens assembly.” To ensure imaging at the proper location, the imaging-position deflector 16 imparts the required lateral deflection of the patterned beam.

So as to be imprintable with the image carried by the patterned beam, the upstream-facing surface of the substrate 23 is coated with a suitable “resist” that is imprintably sensitive to exposure by the patterned beam. When forming the image on the substrate, the projection-lens assembly “reduces” (demagnifies) the aerial image. Thus, the image as formed on the substrate 23 is smaller (usually by a defined integer-ratio factor termed the “demagnification factor”) than the corresponding region illuminated on the reticle 10. By thus causing imprinting on the surface of the substrate 23, the apparatus of FIG. 2 achieves “transfer” of the pattern image from the reticle 10 to the substrate 23.

The components of the depicted electron-optical system situated between the reticle 10 and the substrate 23 collectively are termed the “projection-optical system.” The substrate 23 is situated on a substrate stage 24 situated downstream of the projection-optical system. As the patterned beam propagates through the projection-optical system, the beam actually travels in a downstream direction through an axially aligned “beam tube” (not shown but well understood in the art) that can be evacuated to a desired vacuum level.

The projection-optical system forms a crossover C.O. of the patterned beam on the optical axis Ax at the back focal plane of the first projection lens 15. The position of the crossover C.O. on the optical axis Ax is a point at which the axial distance between the reticle 10 and substrate 23 is divided according to the demagnification ratio. Situated between the crossover C.O. (i.e., the back focal plane) and the reticle 10 is a scattering aperture 18. The scattering aperture 18 comprises an aperture plate that defines an aperture typically centered on the axis Ax. Thus, with the scattering aperture 18, most of the electrons of the patterned beam that were scattered during transmission through the reticle 10 are blocked so as not to reach the substrate 23.

A backscattered-electron (BSE) detector 22 is situated immediately upstream of the substrate 23. The BSE detector 22 is configured to detect and quantify electrons backscattered from certain marks situated on the upstream-facing surface of the substrate 23 or on an upstream-facing surface of the substrate stage 24. For example, a mark on the substrate 23 can be scanned by a beam that has passed through a corresponding mark pattern on the reticle 10. By detecting backscattered electrons from the mark at the substrate, it is possible to determine the relative positional relationship of the reticle 10 and the substrate 23.

The substrate 23 is mounted to the substrate stage 24 via a wafer chuck 32, which presents the upstream-facing surface of the substrate 23 in an XY plane. The substrate stage 24 (with chuck 32 and substrate 23) is movable in the X and Y directions. Thus, by simultaneously scanning the reticle stage 11 and the substrate stage 24 in mutually opposite directions, it is possible to transfer each subfield within the optical field of the illumination-optical system as well as each subfield outside the optical field to corresponding regions on the substrate 23. The substrate stage 24 also includes a “position detector” 25 configured similarly to the position detector 12 of the reticle stage 11.

Each of the lenses 2, 3, 9, 15, 19 and deflectors 5, 8, 16 is controlled by a controller 31 via a respective coil-power controller 2a, 3a, 9a, 15a, 19a and 5a, 8a, 16a. Similarly, the reticle stage 11 and substrate stage 24 are controlled by the controller 31 via respective stage drivers 11a, 24a. The position detectors 12, 25 produce and route respective stage-position signals to the controller 31 via respective interfaces 12a, 25a each including amplifiers, analog-to-digital (A/D) converters, and other circuitry for achieving such ends. In addition, the BSE detector 22 produces and routes signals to the controller 31 via a respective interface 22a.

From the respective data routed to the controller 31, as a subfield is being transferred the controller 31 ascertains, inter alia, any control errors of the respective stage positions. To correct such control errors, the imaging-position deflector 16 is energized appropriately to deflect the patterned beam. Thus, a reduced image of the illuminated subfield on the reticle 10 is transferred accurately to the desired target position on the substrate 23. This real-time correction is made as each respective subfield image is transferred to the substrate 23, and the subfield images are positioned such that they are stitched together properly on the substrate 2.

The upstream-facing surface of the substrate stage includes a calibration mark 33 used for calibrating the substrate stage 24. Electrons backscattered from the calibration mark 33 are detected by the BSE detector 22. For example, the electron beam passing through a corresponding mark pattern on the reticle 10 is scanned across the calibration mark 33. By detecting electrons backscattered from the calibration mark 33 in this manner, it is possible to determine changes in beam characteristics as well as changes in relative positional relationships of the reticle 10 and substrate 23 with each other and with the projection-optical system.

A Faraday cup 40 is situated on the upstream-facing of the substrate stage, near an end of the stage. The Faraday cup 40 measures the beam current of the electron beam incident on the Faraday cup (and hence on the substrate stage 24). An ammeter 35 (or other suitable electrical-current measuring device, termed generally an “ammeter”) is connected to the Faraday cup 40.

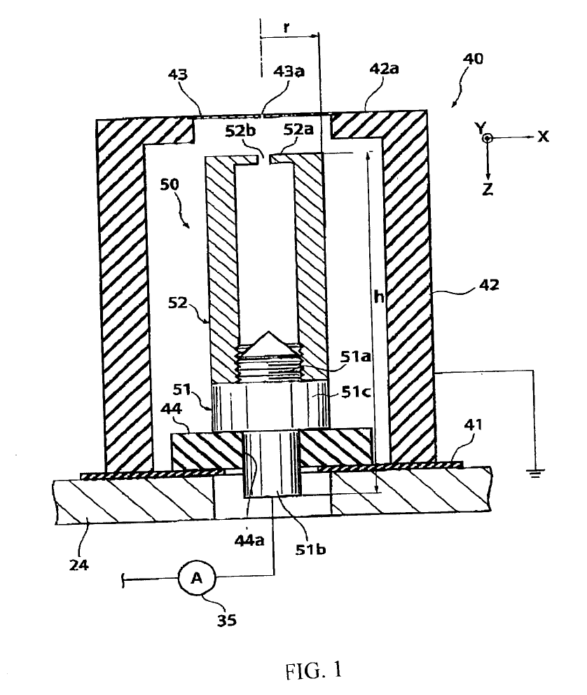

A representative embodiment of a Faraday cup 40 is shown in FIG. 1, which provides an elevational section of the Faraday cup situated on the substrate stage 24. Between the Faraday cup 40 and the upstream-facing surface of the substrate stage 24 is a bottom plate 41 configured so as to have a flat annular profile and a particular thickness. The cup 40 comprises a housing 42, configured as a hollow cylinder, mounted to the bottom plate 41. The “upper” end of the housing defines a radially inwardly directed flange 42a, which prevents electrons entering the housing 42 from exiting the housing. The bottom plate 41 and housing 42 desirably are made of an insulator such as ceramic, with a conductive-metal coating on the surfaces thereof. The conductive-metal coatings on the bottom plate 41 and housing 42 are electrically grounded to prevent them from becoming electrically charged due to impingement by the electrons of the incident beam and by backscattered electrons.

The flange 42a defines an opening that is spanned by an aperture plate 43. The aperture plate 43, which is planar and has a predetermined thickness, is secured centrally with respect to the opening in the flange 42a. A small hole 43a is defined in the center of the aperture plate 43. The aperture plate 43 desirably is made of a metal such as tantalum, molybdenum, or the like. The aperture plate 43 is secured to the metal-film-coated housing 42 such that electrons incident on the hole 43a in the aperture plate 43 pass through the hole 43a and are scavenged, thereby avoiding charge accumulations in the Faraday cup 40.

Mounted to the bottom plate 41 inside the housing 42 is an insulated stand 44 configured as a circular plate-like member having a defined thickness. The insulated stand 44 desirably is made of a material such as ceramic or the like, but lacks a conductive-metal coating. The insulated stand 44 defines a centrally located hole 44a extending in the Z-direction. A main body 50 of the Faraday cup 40, desirably substantially cylindrical in profile, is electrically isolated from the housing 42 by the bottom plate 41. The main body 50 is fitted into the hole 44a.

The main body 50 comprises a lower base member 51 and an upper sleeve member 52. The base member 51 and sleeve member 52 are fabricated from a material such as high-resistance titanium (having a volume resistivity of approximately 10⁻⁶ Ω·m or higher and a total volume of 150 mm³ or less). The ammeter 35 is connected to the base member 51, and is used for measuring the current of electrons incident on the main body 50. The outer diameter and length of the main body 50 are denoted “r” and “h”, respectively.

The lower base member 51 comprises a relatively wide and thick cylindrical shoulder 51c, a threaded portion 51a extending upward from the shoulder 51c, and a relatively small-diameter cylindrical stem 51b extending downward. The stem 51b fits into the hole 44a in the insulated stand 44. The shoulder 51c rests on the upper surface of the insulated stand 44. The distal end of the threaded portion 51a has a conical configuration, which prevents electrons incident thereon from being reflected directly upward (thereby preventing such electrons from propagating back through the aperture plate 43. The proximal end of the sleeve member 52 has a female thread into which the male threaded portion 51a of the lower base member is threaded. Thus, the sleeve member 52 is secured to the lower base member 51.

As noted above, the sleeve member 52 desirably is configured as a hollow cylinder. The distal end of the sleeve member 52 includes a radially inwardly directed flange 52a that prevents incident electrons from propagating into the wall of the housing 42. The flange 52a defines a centrally located hole 52b having a diameter slightly larger than the diameter of the hole 43a in the aperture plate 43. The holes 43a, 52b have respective centers located on the same Z-axis. Thus, almost all the electrons that pass through the hole 43a enter the sleeve member through the hole 52b, thereby allowing more accurate current measurements to be obtained by the ammeter 35.

As noted above, the main body 50 of the Faraday cup desirably has a high electrical resistance but is relatively small so as to provide better suppression of eddy currents generated in the Faraday cup 40 itself.

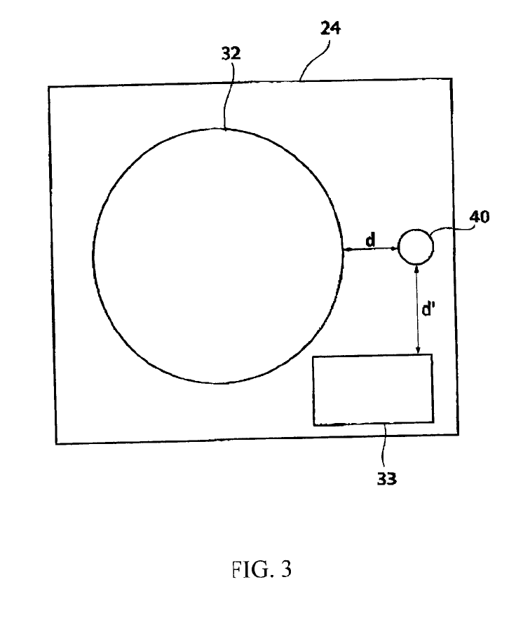

FIG. 3 is a plan view showing an exemplary disposition of the Faraday cup 40 relative to the substrate stage 24, an electrostatic wafer chuck 32 mounted on the substrate stage 24, and the calibration mark 33. In FIG. 3, “d” is the closest distance between the main body 50 (located inside the Faraday cup 40) and the electrostatic chuck 32. The distance denoted “d”′ is the closest distance between the main body 50 and the calibration mark 33. The distance d is established as described below. Also, the distance d′ should be a suitable distance.

The image-placement error IPE of the electron beam, scanning the substrate 23 (secured to the chuck 32) and the calibration mark 33, caused by magnetic fields created by eddy currents generated in the Faraday cup 40 is approximated by the following Equation (1). Equation (1) is based on the magnetic-field state of the microlithography system, the shape of the Faraday cup 40, and other variables. Hence, the equation should be modified appropriately if significant changes are made to these variables.

$$IPE = \sqrt{\frac{Q}{2 {M}_{e} {V}_{acc}}} \frac{{μ}_{0}}{4 π} ( σ VB ) ( 4 {r}^{3} h ) \frac{\frac{{H}^{3}}{{( {H}^{2} + {d}^{2} )}^{\frac{3}{2}}}}{3 d} \qquad ( 1 )$$

wherein Q is the charge of an electron, Mₑ is the mass of an electron (9.1093897×10⁻³¹ kg), V_{acc} is the beam-acceleration voltage (100 kV), μ₀ is the magnetic permeability of a vacuum (4η×10⁻⁷ H/m), σ is the conductivity of the main body 50 (items 51 and 52 in FIG. 1), V is the stage velocity, B is the magnetic flux density in the Z-direction at the position of the main body 50, and H is a constant approximately equal to the bore diameter of the projection lens plus the axial distance between the substrate and projection lens. (It is desirable that the projection lens be adequately isolated from any magnetic fields generated by eddy currents in the Faraday cup.) The bore diameter of the projection lens is the diameter of the magnetic pole of the lens (i.e., the pole facing the substrate). Hence, H is approximately equal to a sum of the diameter of the magnetic pole of the projection lens and the axial distance of the pole to the substrate.

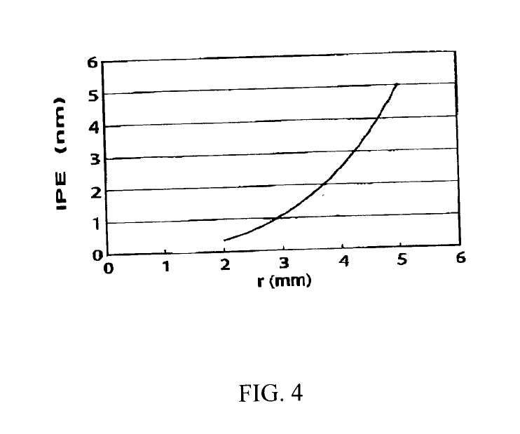

The image-placement error IPE achieved with the parameters “r” and “d” (FIG. 3) of the main body 50 is established as follows. FIG. 4 is a graph of the image-placement error IPE as a finction of the radius r of the main body 50 of the Faraday cup, particularly over the range of r=2 to r=5 mm. At r=2 mm, IPE is about 0.3 nm; at r=3 mm, IPE is about 1.1 nm; and at r=5 mm, IPE is about 5.0 nm. These data define a tertiary curve, exhibiting a large displacement.

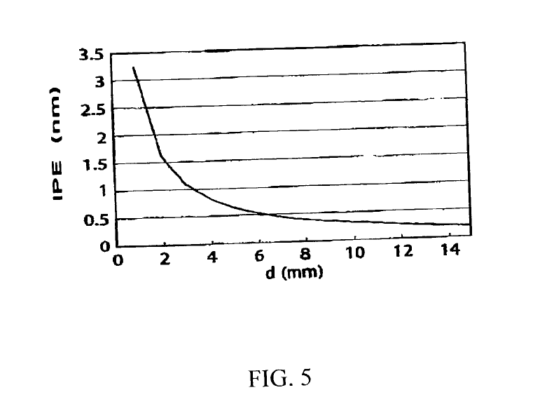

FIG. 5 is a graph showing image-placement error IPE as a function of the distance d, particularly over the range of d=1 mm to d=15 mm. At d=1 mm, IPE is about 3.3 nm; at d=6 mm, IPE is about 0.6 nm; and at d=15 mm, IPE is about 0.2 nm. These data reveal that displacement decreases exponentially with increases in d.

The disposition and placement of the Faraday cup are calculated using Equation (1) and with reference to FIGS. 4 and 5. First, the hypothetically allowed positional displacement of the beam due to eddy currents in the Faraday cup is set at 1 nm or less. For example, if r=2 mm, h=10 mm, and d>4 mm according to Equation (1), FIG. 4, and FIG. 5, then the positional displacement of the Faraday cup can be maintained at the stipulated 1 nm or less.

Thus, by appropriately positioning the main body 50 of the Faraday cup from the optical axis of the CPB optical system, undesirable effects of eddy currents in the Faraday cup on the beam are reduced to inconsequential levels.

Even though a Faraday cup was described with reference to FIGS. 1-5 herein, it will be understood that this configuration is not limiting. Alternative Faraday cups can be configured as having, for example, conductive metal where the cup is mounted to the substrate stage.

Whereas the invention has been described in connection with multiple embodiments, it will be understood that the invention is not limited to those embodiments. On the contrary, the invention is intended to encompass all modifications, alternatives, and equivalents as may be included within the spirit and scope of the invention, as defined by the appended claims.

What is claimed is:

1. A Faraday cup, configured to capture charged particles of an incident charged particle beam, the Faraday cup being connectable to an electrical-current measuring device and being constructed of a material having a volume resistivity of approximately 10⁻⁶ Ω·m or higher.

2. The Faraday cup of claim 1, wherein the electrical-current measuring device is an ammeter.

3. The Faraday cup of claim 1, further comprising an electrically conductive portion having a volume of 150 mm³ or less.

4. A Faraday cup, configured to capture electrons of an incident electron beam, the Faraday cup being connected to an electrical-current measuring device, the Faraday cup comprising an electrically conductive portion having a volume of 150 mm³ or less.

5. The Faraday cup of claim 4, wherein the electrical-current measuring device is an ammeter.

6. A microlithographic exposure apparatus, comprising the Faraday cup of claim 1.

7. A microlithographic exposure apparatus, comprising the Faraday cup of claim 4.

8. A microlithographic exposure apparatus, comprising:
a charged-particle-beam (CPB) optical system;
a substrate stage situated relative to the CPB optical system and comprising a substrate-holding region and a calibration mark, the substrate stage being configured to hold a lithographic substrate at the substrate-holding region, the substrate stage being movable so as to allow the CPB optical system to focus a charged particle beam onto a selected location on an exposure-sensitive surface of the substrate held on the substrate-holding region, so as to expose the surface of the substrate in a lithographic manner; and
a Faraday cup situated on the substrate stage at a distance of at least 4 mm from the substrate-holding region of the substrate stage or from the calibration mark, the Faraday cup being configured for measuring a beam current of a charged particle beam incident on the Faraday cup.

9. The apparatus of claim 8, wherein the charged particle beam is an electron beam.

10. The apparatus of claim 8, wherein the Faraday cup is made of a material having a volume resistivity of at least approximately 10⁻⁶ Ω·m.

11. The apparatus of claim 8, wherein the Faraday cup comprises an electrically conductive portion having a volume of 150 mm³ or less.

12. The apparatus of claim 1 1, wherein the Faraday cup is made of a material having a volume resistivity of at least approximately 10⁻⁶ Ω·m

13. In a microlithography method in which a pattern is exposed lithographically onto a lithographic substrate using a charged particle beam, the substrate being mounted, for exposure, on a substrate stage, a method for measuring a beam current of the charged particle beam as incident on the substrate stage, comprising:
mounting a Faraday cup at a location relative to the charged particle beam and the substrate stage such that the Faraday cup can capture charged particles of an incident charged particle beam, the Faraday cup comprising a material having a volume resistivity of approximately 10⁻⁶ Ω·m or higher;
connecting the Faraday cup to an electrical-current measuring device; and
based on data produced by the electrical-current measuring device as the charged particle beam is incident on the Faraday cup, determining a beam current of the beam.

14. The method of claim 13, wherein the Faraday cup comprises an electrically conductive portion having a volume of 150 mm³ or less.

15. In a microlithography method in which a pattern is exposed lithographically onto a lithographic substrate using a charged particle beam, the substrate being mounted, for exposure, on a substrate stage, a method for measuring a beam current of the charged particle beam as incident on the substrate stage, comprising:
mounting a Faraday cup at a distance of at least 4 mm from a substrate- holding region of the substrate stage or from a calibration mark on the substrate stage, the Faraday cup being configured for measuring a beam current of a charged particle beam incident on the Faraday cup.
connecting the Faraday cup to an electrical-current measuring device; and
based on data produced by the electrical-current measuring device as the charged particle beam is incident on the Faraday cup, determining a beam current of the beam.

16. The method of claim 15, wherein the Faraday cup comprises a material having a volume resistivity of approximately 10⁻⁶ Ω·m or higher;

17. The method of claim 16, wherein the Faraday cup comprises an electrically conductive portion having a volume of 150 mm³ or less.

18. The method of claim 15, wherein the Faraday cup comprises an electrically conductive portion having a volume of 150 mm³ or less.
